(19) United States
(12) Patent Application Publication
(10) Pub. No.: US 2013/0193385 A1
(43) Pub. Date: Aug. 1, 2013

(54) ELECTROPHORETIC DISPERSION

(71) Applicants: Yu Li, Fremont, CA (US); Hui Du, Milpitas, CA (US); Haiyan Gu, Fremont, CA (US)

(72) Inventors: Yu Li, Fremont, CA (US); Hui Du, Milpitas, CA (US); Haiyan Gu, Fremont, CA (US)

(21) Appl. No.: 13/360,482

(22) Filed: Jan. 27, 2012

(51) Int. Cl. H01B 1/12; H01B 1/20; H01B 1/00

(52) U.S. Cl. 252/519.33; 252/500

(57) ABSTRACT

The present invention is directed to an electrophoretic dispersion comprising charged pigment particles dispersed in a solvent or solvent mixture, wherein the pigment particles have an average aggregation size more than 2 times their primary size. The electrophoretic dispersion of the present invention is capable of improving image bistability through adjusting the aggregation size of the charged pigment particles.

### FIELD OF THE INVENTION

The present invention is directed to an electrophoretic dispersion, especially an electrophoretic dispersion capable of improving image bistability through adjusting the aggregation size of the charged pigment particles.

### BACKGROUND OF THE INVENTION

An electrophoretic display (EPD) is a non-emissive device based on the electrophoresis phenomenon influencing charged pigment particles dispersed in a dielectric solvent. An EPD typically comprises a pair of spaced-apart plate-like electrodes. At least one of the electrode plates, typically on the viewing side, is transparent. An electrophoretic dispersion composed of a dielectric solvent with charged pigment particles dispersed therein is enclosed between the two electrode plates.

An electrophoretic dispersion may have one type of charged pigment particles dispersed in a solvent or solvent mixture of a contrasting color. In this case, when a voltage difference is imposed between the two electrode plates, the pigment particles migrate by attraction to the plate of polarity opposite that of the pigment particles. Thus, the color showing at the transparent plate can be either the color of the solvent or the color of the pigment particles. Reversal of plate polarity will cause the pigment particles to migrate to the opposite plate, thereby reversing the color.

Alternatively, an electrophoretic dispersion may have two types of pigment particles of contrasting colors and carrying opposite charges and the two types of pigment particles are dispersed in a clear solvent or solvent mixture. In this case, when a voltage difference is imposed between the two electrode plates, the two types of pigment particles would move to opposite ends (top or bottom) in a display cell. Thus one of the colors of the two types of the pigment particles would be seen at the viewing side of the display cell.

For all types of the electrophoretic displays, the dispersion contained within the individual display cells of the display is undoubtedly one of the most crucial parts of the device. The composition of the dispersion determines, to a large extent, the lifetime, contrast ratio, switching rate and bistability of the device.

For the pigment particles in the dispersion, a polymer layer is usually grafted over their surface to facilitate dispersion of the pigment particles in the dispersing solvent and hence the polymer layer is generally solvent compatible. For example, when a hydrocarbon solvent is used as the dispersing solvent, it is desirable to select a polymer with long alkyl side chains as the outer coating layer over the pigment particles. Such surface modified pigment particles can provide a good contrast ratio, but the resulting image bistability is poor due to the strong inter-particle repulsion force introduced by the surface-grafted polymers.

### SUMMARY OF THE INVENTION

The present invention is directed to an electrophoretic dispersion comprising charged pigment particles dispersed in a solvent or solvent mixture, wherein the pigment particles have an average aggregation size more than 2 times their primary size.

In one embodiment, the pigment particles have an average aggregation size in the range of about 2 to about 10 times their primary size.

In one embodiment, the pigment particles are formed from core particles coated with a copolymer formed from a first type of monomer and a second type of monomer, the homopolymer of the first type of monomer is incompatible with the solvent or solvent mixture in which the pigment particles are dispersed and the homopolymer of the second type of monomer is compatible with the solvent or solvent mixture in which the pigment particles are dispersed.

In one embodiment, the copolymer is a random copolymer or a block copolymer.

In one embodiment, the first type of monomer has short alkyl or aromatic side chains. In one embodiment, the short alkyl side chain has less than five carbon atoms.

In one embodiment, the first type of monomer is styrene, benzyl 2-methylacrylate, methyl acrylate, butyl acrylate, vinyl pyridine, 2-hydoxyethyl acrylate, dimethylaminoethyl methacrylate, acrylic acid or vinyl phosphoric acid.

In one embodiment, the second type of monomer has long alkyl or branched side chains. In one embodiment, the side chain has five or more carbon atoms.

In one embodiment, the second type of monomer is lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate or n-octadecyl methacrylate.

In one embodiment, the solvent or solvent mixture is aliphatic hydrocarbon based.

In one embodiment, the molar ratio of the first type of monomer to the second type of monomer is between 5:1 to 1:10.

In one embodiment, the molar ratio of the first type of monomer to the second type of monomer is between 2:1 to 1:5.

In one embodiment, the core particles are inorganic particles. In one embodiment, the inorganic particles are TiO₂ particles.

In one embodiment, the core particles are organic particles.

In one embodiment, the dispersion further comprises a charge control agent.

In one embodiment, the charged pigment particles are of the same color and carry the same charge polarity.

In one embodiment, the charged pigment particles are of two different types and at least one of which is formed from core particles coated with a copolymer formed from a first type of monomer and a second type of monomer, the homopolymer of the first type of monomer is incompatible with the solvent or solvent mixture in which the pigment particles are dispersed and the homopolymer of the second type of monomer is compatible with the solvent or solvent mixture in which the pigment particles are dispersed.

### DETAILED DESCRIPTION OF THE INVENTION

The present invention relates to pigment particles suitable for use in an electrophoretic dispersion. It has been found that the electrophoretic dispersion comprising pigment particles with an average aggregation size more than 2 times their primary size, preferably in the range of 2 to 10 times their primary size, show improved image bistability without sacrificing other display performance parameters, such as switching speed and contrast ratio. This type of pigment particles is preferably surface-grafted by polymers. Depend on the compatibility of the grafted polymer to the dispersing solvent, the agglomeration size of the pigment particles in the dispersion can be adjusted.

The term “primary size” is intended to refer to the average size of a single un-aggregated particle.

The term “aggregation size” is intended to refer to the average size of aggregated particles in their dispersed state in a solvent or solvent mixture.

According to the present invention, the polymer grafted to the surface of the pigment particle may be a copolymer, such as random copolymer or a block copolymer, formed from two types of monomer, a first type of monomer and a second type of monomer. The compatibility of the surface grafted polymer to the solvent or solvent mixture in which the pigment particles are dispersed can be adjusted by selecting an appropriate molar ratio of the first type of monomer to the second type of monomer. For this purpose, the homopolymer of the first type of monomer is preferred to be incompatible with the solvent or solvent mixture in which the pigment particles are dispersed whereas the homopolymer of the second type of monomer is preferred to be compatible with the solvent or solvent mixture in which the pigment particles are dispersed.

For example, if an aliphatic hydrocarbon based solvent is used, the first type of monomer is preferred to have short alkyl (less than five carbon atoms) or aromatic side chains. Such monomers may include, but are not limited to, styrene, benzyl 2-methylacrylate, methyl acrylate, butyl acrylate, vinyl pyridine, 2-hydoxyethyl acrylate, dimethylaminoethyl methacrylate, acrylic acid, vinyl phosphoric acid or the like.

The second type of monomer, in this case, is preferred to have longer alkyl or branched side chains (five or more carbon atoms). Such monomers may include, but are not limited to, lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, n-octadecyl methacrylate or the like.

The polymerization is typically performed under the same or similar conditions for conventional free-radical polymerization. Polymerization employing the first type of monomer and the second type of monomer is suitably carried out at a reaction temperature in the range of about 50 to about 100° C., preferably in the range of about 60 to about 80° C., optionally in the presence of a chain transfer agent, such as 2-(dodecylthiocarbonothioylthio)-2-methylpropionic acid and/or a free radical initiator, such as 2,2′-azobis(isobutyronitrile).

By adjusting the loading ratio of two different types of monomer, it is possible to control the agglomeration size of the pigment particles. The loading weight ratio of the first type of monomer to the second type of monomer is preferably between 5:1 to 1:10, more preferably between 2:1 to 1:5. Usually, with the increase of the ratio of the first monomer to the second monomer, the agglomeration size of the pigment particles increases.

While an aliphatic hydrocarbon solvent is specifically mentioned, it is noted that other solvent or solvent mixture may also be used. For example, when a fluorinated solvent is used, the first type of monomer may be any acrylates or methacrylates which do not contain fluorinated groups, while the second type of monomer may be any acrylates or methacrylates with fluorinated alkyl (of three or more carbon atoms) side chains.

In general, the solvent in which the pigment particles are dispersed preferably has a low viscosity and a dielectric constant in the range of about 2 to about 30, preferably about 2 to about 15 for high particle mobility. Examples of such a solvent may include hydrocarbons such as isopar, decahydronaphthalene (DECALIN), 5-ethylidene-2-norbornene, fatty oils, paraffin oil; silicon fluids; aromatic hydrocarbons such as toluene, xylene, phenylxylylethane, dodecylbenzene and alkylnaphthalene; halogenated solvents such as perfluorodecalin, perfluorotoluene, perfluoroxylene, dichlorobenzotrifluoride, 3,4,5-trichlorobenzotri fluoride, chloropentafluoro-benzene, dichlorononane, pentachlorobenzene; and perfluorinated solvents such as FC-43, FC-70 and FC-5060 from 3M Company, St. Paul Minn., low molecular weight halogen containing polymers such as poly(perfluoropropylene oxide) from TCI America, Portland, Oreg., poly(chlorotrifluoro-ethylene) such as Halocarbon Oils from Halocarbon Product Corp., River Edge, N.J., perfluoropolyalkylether such as Galden from Ausimont or Krytox Oils and Greases K-Fluid Series from DuPont, Deleware, polydimethylsiloxane based silicone oil from Dow-corning (DC-200). The solvent or solvent mixture may be colored by a dye or pigment.

The core pigment particles over which the polymer layer is formed may be inorganic or organic pigment particles. Inorganic pigment particles may include, but are not limited to TiO₂, ZrO₂, ZnO, Al₂O₃, Cl pigment black 26 or 28 or the like (e.g., manganese ferrite black spinel or copper chromite black spinel). Organic pigment particles may include, but are not limited to, phthalocyanine blue, phthalocyanine green, diarylide yellow, diarylide AAOT yellow, and quinacridone, azo, rhodamine, perylene pigment series from Sun Chemical, Hansa yellow G particles from Kanto Chemical, and Carbon Lampblack from Fisher.

The pigment particles may carry a natural charge or are charged through the presence of a charge controlling agent.

The electrophoretic dispersion of the present invention may further comprise additives such as a dispersant, surfactant and other additives known to be used in an electrophoretic dispersion.

The pigment particles prepared according to the present invention may be used in a one-particle-type dispersion system or a two-particle-type dispersion. In the one particle system, the charged pigment particles are of the same color and carrying the same charge polarity. In a two particle system, there are two types of pigment particles of contrasting colors and carrying opposite charge polarity and at least one of the two types of the pigment particles is formed from core particles coated with a copolymer, such as a random copolymer or a block copolymer, and said copolymer is formed from a first type of monomer and a second type of monomer, the homopolymer of the first type of monomer is incompatible with the solvent or solvent mixture in which the pigment particles are dispersed and the homopolymer of the second type of monomer is compatible with the solvent or solvent mixture in which the pigment particles are dispersed.

### EXAMPLE 1

### Step A: Deposition of Vinylbenzylaminoethylaminopropyl-trimethoxysilane on Black Pigment Particles

To a 1 L reactor, Black 444 (Shepherd, 80 g), isopropanol (640 g), DI water (24 g), ammonium hydroxide (28%, 0.8 g) and Z-6032 (Dow Corning, 40 g, 40% in methanol) were added. The reactor was heated to 60° C. with mechanical stirring in a sonication bath. After 3 hours, the mixture was centrifuged at 6000 rpm for 10 minutes. The solids were redispersed in isopropanol (300 g), centrifuged and dried at 50° C. under vacuum overnight to produce 78 g of the desired product.

### Step B: Preparation of Surface Grafted Polymer on Pigment Particles

To a 250 mL flask, the particles (5 g) prepared from Step A and 25 g of toluene were added and sonicated for 30 minutes, followed by the addition of 2-ethylhexyl acrylate (10 g), n-butyl acrylate (10 g), 2-(dodecylthiocarbonothioylthio)-2-methylpropionic acid (0.1 g) and azobisisobutyronitrile (AIBN) (10 mg). The flask was purged with nitrogen for 20 minutes and then heated to 80° C. After 16 hours, the polymer coated pigment particles were recovered by centrifugation at 6000 rpm for 10 minutes. The solids produced were redispersed in toluene and centrifuged. This cycle was repeated twice and the solids were dried at 50° C. under vacuum to produce 4.8 g of the final product. The average aggregation size of pigment particles is about 7 times of the primary size of the particles.

While the present invention has been described with reference to the specific embodiments thereof, it should be understood by those skilled in the art that various changes may be made and equivalents may be substituted without departing from the scope of the invention. In addition, many modifications may be made to adapt a particular situation, materials, compositions, processes, process step or steps, to the objective and scope of the present invention. All such modifications are intended to be within the scope of the claims appended hereto.

What is claimed is:

1. An electrophoretic dispersion comprising charged pigment particles dispersed in a solvent or solvent mixture, wherein the pigment particles have an average aggregation size more than 2 times their primary size.

2. The dispersion of claim 1, wherein the pigment particles have an average aggregation size in the range of about 2 to about 10 times their primary size.

3. The dispersion of claim 1, wherein said pigment particles are formed from core particles coated with a copolymer formed from a first type of monomer and a second type of monomer, the homopolymer of the first type of monomer is incompatible with the solvent or solvent mixture in which the pigment particles are dispersed and the homopolymer of the second type of monomer is compatible with the solvent or solvent mixture in which the pigment particles are dispersed.

4. The dispersion of claim 3, wherein the copolymer is a random copolymer or a block copolymer.

5. The dispersion of claim 3, wherein the first type of monomer has short alkyl or aromatic side chains.

6. The dispersion of claim 5, wherein said short alkyl side chain has less than five carbon atoms.

7. The dispersion of claim 5, wherein said first type of monomer is styrene, benzyl 2-methylacrylate, methyl acrylate, butyl acrylate, vinyl pyridine, 2-hydoxyethyl acrylate, dimethylaminoethyl methacrylate, acrylic acid or vinyl phosphoric acid.

8. The dispersion of claim 3, wherein said second type of monomer has long alkyl or branched side chains.

9. The dispersion of claim 8, wherein the side chain has five or more carbon atoms.

10. The dispersion of claim 8, wherein said second type of monomer is lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, or n-octadecyl methacrylate.

11. The dispersion of claim 1, wherein the solvent or solvent mixture is aliphatic hydrocarbon based.

12. The dispersion of claim 3, wherein the molar ratio of the first type of monomer to the second type of monomer is between 5:1 to 1:10.

13. The dispersion of claim 3, wherein the molar ratio of the first type of monomer to the second type of monomer is between 2:1 to 1:5.

14. The dispersion of claim 3, wherein said core particles are inorganic particles.

15. The dispersion of claim 14, wherein the inorganic particles are TiO₂ particles.

16. The dispersion of claim 3, wherein said core particles are organic particles.

17. The dispersion of claim 1, further comprising a charge control agent.

18. The dispersion of claim 1, wherein the charged pigment particles are of the same color and carry the same charge polarity.

19. The dispersion of claim 1, wherein the charged pigment particles are of two different types and at least one of which is formed from core particles coated with a copolymer formed from a first type of monomer and a second type of monomer, the homopolymer of the first type of monomer is incompatible with the solvent or solvent mixture in which the pigment particles are dispersed and the homopolymer of the second type of monomer is compatible with the solvent or solvent mixture in which the pigment particles are dispersed.
